(19) United States
(12) Patent Application Publication
(10) Pub. No.: US 2006/0270582 A1
(43) Pub. Date: Nov. 30, 2006

(54) Polymer-containing detergent compositions and their use

(76) Inventors: Dieter Boeckh, Limburgerhof (DE); Arturo Luis Casado Dominguez, Brussels (BE); Joanna Margaret Clarke, Beijing (CN); Jun Ma, Beijing (CN); Lucia Mendez-Mata, Newcastle (GB); Eva Schneiderman, Mason, OH (US); Philip Frank Souter, Morpeth (GB)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/443,242

(22) Filed: May 30, 2006

Related U.S. Application Data
(60) Provisional application No. 60/685,943, filed on May 31, 2005.

(51) Int. Cl. C11D 3/48

(52) U.S. Cl. 510/386

(57) ABSTRACT

A detergent composition includes a polymer in combination with a surfactant and/or a builder and adjunct ingredients. The polymer may provide improved grease cleaning, stain removal, clay suspension, and/or suds boosting benefits. In addition, the polymer may provide a synergistic benefit when employed with a lipase.

### CROSS REFERENCE TO RELATED APPLICATION

This application claims the benefit of U.S. Provisional Application No. 60/685,943, filed on May 31, 2005.

### FIELD OF THE INVENTION

The invention relates to polymer-containing detergent compositions and their use.

### BACKGROUND OF THE INVENTION

Improved removal of greasy soils, stains, and multi-cycle whiteness maintenance, are constant goals for laundry detergent manufacturers. Enzymes have been used in detergents since the 1980s to remove fatty soils by breaking down triglyceride-based fatty soils. Many polymers are also known in detergent compositions. See, WO 91/09932 to Manchin, et al., published on Jul. 11, 1991; EP 219 048 A2 to Kud, et al., published on Apr. 22, 1987; and EP 358 474 A to Boscamp, published on Mar. 14, 1990.

It has now been surprisingly found that by employing certain optimized polymers, comparable cleaning performance may be achieved, even though less surfactant and/or inorganic detergent builder is employed in the laundry detergent formulation.

Accordingly, the need exists for improved polymers which provide improved grease cleaning performance, stain removal, multi-cycle whiteness maintenance, clay suspension, synergy with enzymes, and/or which allow a reduction of traditional inorganic detergent builders or surfactants.

### SUMMARY OF THE INVENTION

The present invention relates to an improved detergent composition containing 0.5-20% polymer, 1-50% surfactant, and the balance adjunct ingredients. The detergent composition has a grease cleaning performance indexₛ of at least 10, or the % polymer:grease cleaning performance indexₛ ratio is at least 1:2.

The invention also relates to an improved detergent composition containing 0.5-20% polymer, 5-40% inorganic detergent builder, and the balance adjunct ingredients. The detergent composition has a grease cleaning performance index_{b} of at least 10 or, the % polymer:grease cleaning performance index_{b} ratio is at least about 1:2.

The invention also relates to an improved detergent composition containing 0.5-20% polymer, 1-50% anionic surfactant, and the balance adjunct ingredients. The detergent's clay suspension index is at least 86, or the suds boosting index is at least 10.

The invention also relates to an improved detergent composition containing 5-20,000 LU/g of the detergent composition of a lipase, 0.25-20% polymer comprising a polyethylene glycol backbone, and the balance adjunct ingredients.

The invention also relates to the use of a polymer in a detergent composition comprising a lipase, to provide a synergistic benefit. The synergistic benefit is selected from improved grease-cleaning, improved stain removal, and/or improved multi-cycle whiteness maintenance. The polymer has a polyethylene glycol backbone. The invention also relates to the use of a polymer in a detergent composition to improve the suds profile thereof. The detergent contains an anionic surfactant and the polymer has a polyethylene glycol backbone.

It has now been found that an improved polymer herein may surprisingly provide a variety of benefits, such as improving grease cleaning, stain removal, multi-cycle whiteness maintenance, and/or the sudsing profile, especially in a laundry detergent composition. The polymer may also provide a significant, synergistic benefit when used in combination with an enzyme, such as a lipase, and especially a first wash lipase. Additionally, while other additives typically only work well on animal fat (beef, chorizo, etc.) or vegetable (peanut, olive, etc.) oils, the present invention has been found to be surprisingly effectively at removing both types of fats/oils.

### DETAILED DESCRIPTION OF THE INVENTION

All temperatures herein are in degrees Celsius (° C.). All weights and percentages herein are by weight of the detergent composition unless specifically noted. The term “comprising” means that other steps, ingredients, elements, etc. which do not adversely affect the end result can be added, and encompasses the terms “consisting of” and “consisting essentially of”.

Incorporated and included herein, as if expressly written, are all ranges of numbers when written in a “from X to Y” or “from about X to about Y” or “X-Y” format. It should be understood that every limit given herein includes every lower or higher limit, as the case may be, as if such lower or higher limit was expressly written herein. Every range given herein includes every narrower range that falls within such broader range, as if such narrower ranges were all expressly written herein.

The polymer herein is a random graft homo or copolymer having a hydrophilic backbone and hydrophobic side chains. Typically, the hydrophilic backbone is less than about 50%, or from about 50% to about 2%, or from about 45% to about 5%, or from about 40% to about 10% by weight of the polymer. The backbone preferably contains monomers selected from the group consisting of unsaturated C₁₋₆ acid, ether, alcohol, aldehyde, ketone or ester, sugar unit, alkoxy unit, maleic anhydride and saturated polyalcohol such as glycerol, and a mixture thereof. The hydrophilic backbone may contain acrylic acid, methacrylic acid, maleic acid, vinyl acetic acid, glucoside, alkylene oxide, glycerol, or a mixture thereof. The polymer may contain either a linear or branched polyalkylene oxide backbone with ethylene oxide, propylene oxide and/or butylene oxide. The polyalkylene oxide backbone may contain more than about 80%, or from about 80% to about 100%, or from about 90% to about 100% or from about 95% to about 100% by weight ethylene oxide. The weight average molecular weight (Mw) of the polyalkylene oxide backbone is typically from about 400 g/mol to 40,000 g/mol, or from about 1,000 g/mol to about 18,000 g/mol, or from about 3,000 g/mol to about 13,500 g/mol, or from about 4,000 g/mol to about 9,000 g/mol. The polyalkylene backbone may be extended by condensation with suitable connecting molecules, such as dicarboxylic acids and/or diisocianates.

The backbone contains a plurality of hydrophobic side chains attached thereto, such as a C₄₋₂₅ alkyl group; polypropylene; polybutylene; a vinyl ester of a saturated monocarboxylic C₁₋₆ acid; and/or a C₁₋₆ alkyl ester of acrylic or methacrylic acid. The hydrophobic side chains may contain, by weight of the hydrophobic side chains, at least about 50% vinyl acetate, or from about 50% to about 100% vinyl acetate, or from about 70% to about 100% vinyl acetate, or from about 90% to about 100% vinyl acetate. The hydrophobic side chains may contain, by weight of the hydrophobic side chains, from about 70% to about 99.9% vinyl acetate, or from about 90% to about 99% vinyl acetate. The hydrophobic side chains may also contain, by weight of the hydrophobic side chains, from about 0.1% to about 10% butyl acrylate, or from about 1% to about 7% butyl acrylate, or from about 2% to about 5% butyl acrylate. The hydrophobic side chains may also contain a modifying monomer, such as styrene, N-vinylpyrrolidone, acrylic acid, methacrylic acid, maleic acid, acrylamide, vinyl acetic acid and/or vinyl formamide, especially styrene and/or N-vinylpyrrolidone, at levels of from about 0.1% to about 10%, or from about 0.1% to about 5%, or from about 0.5% to about 6%, or from about 0.5% to about 4%, or from about 1% to about 3%, by weight of the hydrophobic side chains.

The polymer may be formed by grafting (a) polyethylene oxide; (b) a vinyl ester from acetic acid and/or propionic acid; and/or a C₁₋₄ alkyl ester of acrylic or methacylic acid; and (c) modifying monomers. The polymer may have the general formula: 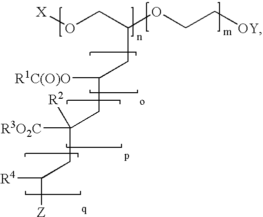
where X and Y are capping units independently selected from H or a C₁₋₆ alkyl; each Z is a capping unit independently selected from H or a C-radical moiety (i.e., a carbon-containing fragment derived from the radical initiator attached to the growing chain as result of a recombination process); each R¹ is independently selected from methyl and ethyl; each R² is independently selected from H and methyl; each R³ is independently a C₁₋₄ alkyl; and each R⁴ is independently selected from pyrrolidone and phenyl groups. The Mw of the polyethylene oxide backbone is as described above. The value of m, n, o, p and q is selected such that the pendant groups form at least 50%, or from about 50% to about 98%, or from about 55% to about 95%, or from about 60% to about 90% of the polymer, by weight. The polymer useful herein typically has a Mw of from about 1,000 g/mol to about 150,000 g/mol, or from about 2,500 g/mol to about 100,000 g/mol, or from about 7,500 g/mol to about 45,000 g/mol, or from about 10,000 g/mol to about 34,000 g/mol.

The radical grafting polymerization reaction is typically carried out with a radical initiator at temperatures below about 100° C., or from about 60° C. to about 100° C., or from about 65° C. to about 90° C., or from about 70° C. to about 80° C. While polymers have previously been disclosed which have grafting temperatures above about 100° C., the lower temperatures and kinetics herein result in a significantly different polymer primary structure. While these are still “random graft polymers”, the lower grafting temperature increases the overall/average size of each individual grafted chain and that the grafted chains are more spaced out across the polymer. So, polymers formed at the lower grafting temperatures are overall more hydrophilic and have comparatively higher cloud points in water than polymers formed at the higher grafting temperatures, even if the same reactants and raw materials are used, and the final Mw and backbone:grafted chain weight ratio is the same. The polymer may have from about 0.5 to about 1.5, or from about 0.6 to about 1.25, or from about 0.75 to about 1.1 graft points per backbone monomer unit, ethylene oxide unit, polyethylene glycol unit, or etc. as is appropriate for that individual polymer. The number of graft points per backbone monomer unit (or other unit as appropriate for that polymer) is determined by NMR spectroscopy analysis of the neat polymer, as solvents may interfere with the NMR measurement.

The polymer may further contain a plurality of hydrolysable moieties, such as ester- or amide-containing moieties which may be partially or fully hydrolyzed. The degree of hydrolysis of the polymer is defined as the mol % of hydrolysable moieties which have been hydrolyzed into the corresponding fragments. Typically, the degree of hydrolysis of the polymer will be no greater than about 75 mol %, or from about 0 mol % to about 75 mol %, or from about 0 mol % to about 60 mol %, or from about 0 mol % to about 40 mol %. In other embodiments, the degree of hydrolysis of the polymer is from about 30 mol % to about 45 mol % or from about 0 mol % to about 10 mol %.

The detergent composition typically contains from about 0.5% to about 20%, or from about 0.6% to about 18%, or from about 0.75% to about 15% or from about 1% to about 12% polymer. However, in a composition containing a lipase, it has been found that surprising results may be achieved when the detergent composition contains from about 0.25% to about 20%, or from about 0.4% to about 20%, or from about 0.5% to about 20%, or from about 0.6% to about 18%, or from about 0.75% to about 15% or from about 1% to about 12% polymer.

The surfactant typically is selected from an anionic surfactant, a nonionic surfactant, a cationic surfactant, a zwitterionic surfactant, an ampholytic surfactant, a semi-polar nonionic surfactant, a Gemini surfactant, and a mixture thereof; or an anionic surfactant, a nonionic surfactant, a zwitterionic surfactant, and a mixture thereof; or an anionic surfactant, a nonionic surfactant, and a mixture thereof; or an anionic surfactant. The detergent composition typically contains from about 1% to about 50%, or from about 3% to about 40%, or from about 5% to about 35% surfactant.

The anionic surfactant useful herein has an alkyl chain length of from about 6 carbon atoms (C₆), to about 22 carbon atoms (C₂₂), and are themselves well-known in the art. Nonlimiting examples of anionic surfactants useful herein include:
a) linear alkyl benzene sulfonates (LAS), especially C₁₁-C₁₈ LAS;
b) primary, branched-chain and random alkyl sulfates (AS) , especially C₁₀-C₂₀ AS;
c) secondary (2,3) alkyl sulfates having formulas (I) and (II) , especially C₁₀-C₂₀ secondary alkyl sulfates: 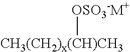
   or 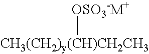
   in these formulas, M is hydrogen or a cation providing charge neutrality depending upon the form isolated by the artisan or the relative pH of the system wherein the compound is used. Non-limiting cations include sodium, potassium, ammonium, and mixtures thereof. x is an integer between 7 and 15, or between 9 and 13; and y is an integer between 8 and 14, or between 9 and 12, inclusive;
d) alkyl alkoxy sulfates (AAₓS), especially C₁₀-C₁₈ AAS where the alkoxy group is ethoxy, and where x is about 1-30;
e) alkyl alkoxy carboxylates, especially C₆-C₁₈ alkyl alkoxy carboxylates, especially with about 1-5 ethoxy units;
f) mid-chain branched alkyl sulfates. See U.S. Pat. No. 6,020,303 granted on Feb. 1, 2000; and U.S. Pat. No. 6,060,443 granted on May 9, 2000 both to Cripe, et al.;
g) mid-chain branched alkyl alkoxy sulfates. See U.S. Pat. No. 6,008,181 granted on Dec. 28, 1999; and U.S. Pat. No. 6,020,303 granted on Feb. 1, 2000 both to Cripe, et al.;
i) methyl ester sulfonate (MES), especially where cold-water laundering is common;
j) alpha-olefin sulfonate (AOS); and
k) primary, branched chain and random alkyl or alkenyl carboxylates, especially those having about 6-18 carbon atoms.

Generally, the detergent composition may contain from about 0.1% to about 25%, or from about 0.5% to about 20%, or from about 1% to about 17% of a nonionic surfactant. While NEODOL® nonionic surfactants from Shell Chemical LP (Houston, Tex., USA) and LUTENSOL® XL and LUTENSOL® XP from BASF Aktiengesellschaft (Mannheim, Germany) are typical, non-limiting examples of such nonionic surfactants include:
a) C₁₂-C₁₈ alkyl ethoxylates (AE);
b) C₆-C₁₂ alkyl phenol alkoxylates where the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF;
d) C₁₄-C₂₂ mid-chain branched alcohols (BA) as discussed in U.S. Pat. No. 6,150,322 to Singleton, et al., granted on Nov. 21, 2000;
e) C₁₄-C₂₂ mid-chain branched alkyl alkoxylates (BAAₓ), especially ethoxylates, and where x is about 1-30. See U.S. Pat. No. 6,153,577 granted on Nov. 28, 2000; U.S. Pat. No. 6,020,303 granted on Feb. 1, 2000; and U.S. Pat. No. 6,093,856 granted on Jul. 25, 2000 all to Cripe, et al.;
f) polyhydroxy fatty acid amides. See U.S. Pat. No. 5,332,528 to Pan and Gosselink, granted on Jul. 26, 1994; WO 92/06162 A1 to Murch, et al., published on Apr. 16, 1992; WO 93/19146 A1 to Fu, et al., published on Sep. 30, 1993; WO 93/19038 A1 to Conner, et al., published on Sep. 30, 1993; and WO 94/09099 A1 to Blake, et al., published on Apr. 28, 1994;
g) ether-capped poly(oxyalkylated) alcohol surfactants. See U.S. Pat. No. 6,482,994 to Scheper and Sivik, granted on Nov. 19, 2002; and WO 01/42408 A2 to Sivik, et al., published on Jun. 14, 2001.

Non-limiting examples of a cationic surfactant include quaternary ammonium surfactants with from 1-26 carbon atoms.
a) alkoxylate quaternary ammonium (AQA) surfactants. See U.S. Pat. No. 6,136,769 to Asano, et al., granted on Oct. 24, 2000;
b) dimethyl hydroxyethyl quaternary ammonium. See U.S. Pat. No. 6,004,922 to Watson and Gosselink granted on Dec. 21, 1999;
c) polyamine cationic surfactants. See WO 98/35002 A1; WO 98/35003 A1, WO 98/35004 A1, WO 98/35005 A1, and WO 98/35006 A1, all to Heinzman and Ingram published on Aug. 13, 1998;
d) cationic ester surfactants. See U.S. Pat. No. 4,228,042 to Letton granted on Oct. 14, 1980; U.S. Pat. No. 4,239,660 to Kingry granted on Dec. 16, 1980; U.S. Pat. No. 4,260,529 to Letton on Apr. 7, 1981; and U.S. Pat. No. 6,022,844 to Baillely and Perkins granted on Feb. 8, 2000; and
e) amino surfactants. See U.S. Pat. No. 6,221,825 to Willimas and Nair granted on Apr. 24, 2001 and WO 00/47708 to Broeckx, et al., published on Aug. 17, 2000, and specifically amido propyldimethyl amine.

Zwitterionic surfactants include derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975. Ampholytic surfactants include C₈₊, or C₈₋₁₈, aliphatic derivatives of secondary or tertiary amines, or aliphatic derivatives of heterocyclic secondary and tertiary amines in which the aliphatic radical can be straight- or branched-chain. Semi-polar nonionic surfactants include water-soluble amine oxides, phosphine oxides, and sulfoxides containing one C₁₀₋₁₈ alkyl moiety and 2 moieties selected from C₁₋₃ alkyl groups and C₁₋₃ hydroxyalkyl groups. See WO 01/32816, U.S. Pat. No. 4,681,704, and U.S. Pat. No. 4,133,779. Gemini Surfactants are compounds having at least two hydrophobic groups and at least two hydrophilic groups per molecule. See, e.g., Chemtech, March 1993, pp. 30-33, and J. Am. Chem. Soc., 115, 10083-90 (1993). These surfactants are typically commodities that are readily-available from a variety of suppliers around the world, in any quantity or quality desired.

The inorganic detergent builder is typically selected from the group consisting of a phosphate builder, a silicate builder, a zeolite builder, and a mixture thereof. The phosphate builder herein includes the alkali metal, ammonium and alkanolammonium AA-677MQ 9 salts of poly-, ortho- and/or meta-phosphate; or the alkali metal salts of poly-, ortho- and/or meta-phosphate; or the sodium and potassium salts of poly-, ortho- and/or meta-phosphate; or sodium tripolyphosphate (STPP).

The inorganic detergent builder may include an alkali metal silicate, a zeolite, and a mixture thereof. Both sheet silicates and amorphous silicates are useful herein as are zeolite A, zeolite X, zeolite P, zeolite MAP, and a mixture thereof. The detergent composition herein typically contains from about 5% to about 40%, or from about 7% to about 35%, or from about 10% to about 30% inorganic detergent builder Which is widely available from multiple suppliers and sources around the world.

A lipase useful herein includes those disclosed in GB 1,372,034 to Dijk and Berg, published Oct. 30, 1974; Japanese Patent Application 53,20487 to Inugai, published Feb. 24, 1978 (Lipase P “Amano” or “Amano-P” from Amano Pharmaceutical Co. Ltd., Nagoya, Japan); LIPOLASE® commercially available from Novozymes A/S (Bagsvaerd, Denmark); EP 341,947 to Cornelissen, et al., issued Aug. 31, 1994; WO 9414951 to Halkier, et al., published Jul. 7, 1994 A to Novo; and WO 9205249 to Clausen, et al., published Apr. 2, 1992.

A “first wash lipase” is a high-efficiency lipase developed to work effectively during the first wash phase of a cleaning process, so that as well as cleaning in the second washing step, a significant improvement in cleaning effect due to lipase enzyme can be found in the first wash-cycle. See, e.g., WO 00/60063 A1 to Vind, et al., published on Oct. 12, 2000; Research Disclosure IP6553D; WO 99/42566 A1 to Borch, et al., published on Aug. 26, 1999; WO 02/062973 A2 to Munk, et al., published on Aug. 5, 2002; WO 97/04078 A1 to Fuglslag, et al., published on Feb. 6, 1997; WO 97/04079 A1 to Fuglslag, et al., published on Feb. 6, 1997; and U.S. Pat. No. 5,869,438 to Svendsen, et al., published on Feb. 9, 1999. The first wash lipase may be sold as LIPEX® (registered tradename of Novozymes), a variant of the Humicola lanuginosa (Thermomyces lanuginosus) lipase (LIPOLASE® registered tradename of Novozymes) with the mutations T231R and N233R.

Lipase is typically present at from about 5 LU/g to about 20,000 LU/g of the detergent composition, or from about 35 LU/g to about 5,000 LU/g of the detergent composition. The LU unit for lipase activity is defined in WO 99/42566 A1 to Borch, et al., published on Aug. 26, 1999. The lipase dosage in the wash solution is typically from about 0.005-5 mg/L, or from about 0.01-0.5 mg/L as enzyme protein. In an embodiment herein, the lipase, and especially the first wash lipase, dosage is from about 0.01-20,000 LU/mL wash solution, or 0.2-5,000 LU/mL wash solution.

The first wash lipase herein is a polypeptide having an amino acid sequence with at least 90% identity with the wild-type lipase derived from Humicola lanuginosa strain DSM 4109 and compared to said wild-type lipase, contains a substitution of an electrically neutral or negatively charged amino acid within 15A of E1 or Q249 with a positively charged amino acid; and may further contain:(a) a peptide addition at the C-terminal; (b) a peptide addition at the N-terminal;(c) meets the following limitations: (i) contains a negatively charged amino acid in position E210 of said wild-type lipase; (ii) contains a negatively charged amino acid in the region corresponding to positions 90-101 of said wild-type lipase; (iii) contains a electrically neutral or negatively charged amino acid at a position corresponding to N94 of said wild-type lipase; and/or (iv) has a negative or neutral net electric charge in the region corresponding to positions 90-101 of said wild-type lipase; and (d) mixture thereof.

The reference lipase used in this composition is the wild-type lipase derived from Humicola lanuginosa strain DSM 4109. It is described in EP 258 068 A2 to Huge-Jensen and Boel published Mar. 2, 1988; and EP 305 216 to Boel and Huge-Jensen published on Mar. 1, 1989 and has the amino acid sequence shown in positions 1-269 of SEQ ID NO: 2 of U.S. Pat. No. 5,869,438. The reference lipase is also referred to herein as LIPOLASE®.

The lipase herein contains one or more (e.g. 2-4, particularly two) substitutions of an electrically neutral or negatively charged amino acid near E1 or Q249 with a positively charged amino acid, preferably R. The substitution is at the surface of the three-dimensional structure within 15 A of E1 or Q249, e.g. at any of positions 1-11, 90, 95, 169, 171-175, 192-211,213-226, 228-258,260-262. The substitution maybe within 10 A of E1 or Q249, e.g. at any of positions 1-7, 10, 175, 195, 197-202, 204-206, 209, 215, 219-224, 230-239, 242-254. The substitution may be within 15 A of E1, e.g. at any of positions 1-11, 169, 171, 192-199, 217-225, 228-240, 243-247, 249, 261-262. The substitution is most preferably within 10 A of E1, e.g. at any of positions 1-7, 10, 219-224 and 230-239. Thus, some preferred substitutions are S3R, S224R, P229R, T231 R, N233R, D234R and T244R.

The lipase may contain a peptide addition attached to C-terminal L269. The peptide addition preferably consists of 1-5 amino acids, e.g. 2, 3 or 4 amino acids. The amino acids of the peptide addition will be numbered 270, 271, etc. The peptide addition may consist of electrically neutral (e.g. hydrophobic) amino acids, e.g. PGL or PG. Or, the lipase peptide addition consists of neutral (e.g. hydrophobic) amino acids and the amino acid C, and the lipase contains substitution of an amino acid with C at a suitable location so as to form a disulfide bridge with the C of the peptide addition. Examples are: 270C linked to G23C or T37C 271 C linked to K24C, T37C, N26C or R81 C 272C linked to D27C, T35C, E56C, T64C or R81 C. Amino acids at positions 90-101 and 210.

The lipase typically meets certain limitations on electrically charged amino acids at positions 90-101 and 210. Thus, amino acid 210 may be negatively charged. E210 may be unchanged or it may have the substitution E21 OD/CN, particularly E21 OD. The lipase may contain a negatively charged amino acid at any of positions 90-101 (particularly 94-101), e.g. at position D96 and/or E99. Further, the lipase may contain an electrically neutral or negatively-charged amino acid at position N94, i.e. N94 (neutral or negative), e.g. N94N/D/E.

Also, the lipase may have a negative or neutral net electric charge in the region 90-101 (particularly 94-101). Thus, the region may be unchanged from LIPOLASE®, having two negatively charged amino acids (D96 and E99) and one positively charged amino acid (K98), and having an electrically neutral amino acid at position 94 (N94), or the region may be modified by one or more substitutions.

Alternatively, two of the three amino acids N94, N96 and E99 may have a negative or unchanged electric charge. Thus, all three amino acids may be unchanged or may be changed by a conservative or negative substitution, i.e. N94 (neutral or negative), D (negative) and E99 (negative). Examples are N94D/E and D96E. Also, one of the three may be substituted so as to increase the electric charge, i.e. N94 (positive), D96 (neutral or positive) or E99 (neutral or positive). Examples are N94K/R, D961/L/N/S/W or E99N/Q/K/R/H.

The lipase contains a positively charged peptide extension at the N-terminal. The peptide extension may consist of 1-15 (particularly 4-10) amino acid residues and preferably contains 1, 2 or 3 positively charged amino acids, most preferably 1, 2 or 3 R. The electric charge at the N-terminal may be further increased by substituting E1 with an electrically neutral or positively charged amino acid, e.g. E1 P. Some preferred peptide extensions are SPIRR, RP(-E), SPIRPRP(-E), SPPRRP(-E) and SPIRPRID(-E).

The peptide extension may contain C (cysteine) attached by a disulfide bridge to a second C in the polypeptide (either C present in Lipolase or introduced by a substitution), e.g. SPPCGRRP(-E), SPCRPR, SPCRPRP(-E), SPPCGRRPRRP(-E), SPPNGSCGRRP(-E), SPPCRRRP(-E) or SCIRR attached to E239C. Further, any peptide extension described in WO 97104079 and WO 97107202 may be used.

As discussed, amino acids are classified as negatively charged, positively charged or electrically neutral according to their electric charge at pH 10. Thus, negative amino acids are E, D, C (cysteine) and Y, particularly E and D. Positive amino acids are R, K and H, particularly R and K. Neutral amino acids are G, A, V, L, 1, P, F, W, S, T M, N, Q and C when forming part of a disulfide bridge. A substitution with another amino acid in the same group (negative, positive or neutral) is termed a conservative substitution. The electrically neutral amino acids may be divided into hydrophobic (G, A, V, L, 1, P, F, W and C as part of a disulfide bridge) and hydrophilic (S, T M, N, Q).

The lipase herein has an amino acid identity of at least 90% (preferably more than 95% or more than 98%) with LIPOLASE®. The degree of identity may be suitably determined by means of computer programs known in the art, such as GAP provided in the GCG program package (Program Manual for the Wisconsin Package, Version 8, August 1994, Genetics Computer Group, 575 Science Drive, Madison, Wis., USA 53711) (Needleman, S. B. and Wunsch, C. D., (1970), Journal of Molecular Biology, 48, 443-45), using GAP with the following settings for polypeptide sequence comparison. GAP creation penalty of 3.0 and GAP extension penalty of 0.1. The lipase enzyme may be incorporated into the detergent composition in any convenient form, generally in the form of a non-dusting granulate, a stabilized liquid or a coated enzyme particle.

The balance of the laundry detergent is typically contains from about 5% to about 70%, or about 10% to about 60% adjunct ingredients such as a brightener, a bluing agent, an other enzyme, a perfume, etc. which are well known in the art.

Brighteners convert non-visible light into visible light thereby making fabric and clothes appear brighter, whiter and/or their colors more vibrant. A bluing agent is typically a slightly bluish dye and/or pigment which attaches to fabrics and which thereby helps to hide yellowish tinges and colors on fabrics so as to make the fabric appear whiter.

Other (i.e., non-lipase) enzymes useful herein include proteases, amylases (α and/or β), cellulases, cutinases, esterase, carbohydrases, peroxidases, laccases, oxygenases, etc., including modified/genetically-engineered enzymes and stabilized enzymes. The enzyme levels of such other enzymes are generally from 0.0001% to 2%, preferably 0.001% to 0.2%, more preferably 0.005% to 0.1% pure enzyme.

The perfume herein provides aesthetic impact to the fabric either during or after laundering. Perfumes are available from, e.g., Givaudan, International Flavors & Fragrances, etc., and are typically present at from about 0.001%-5%.

Test Methods

The grease cleaning test is prepared as follows: A standardized stain pattern containing separate spots of dirty cooking oil, bacon grease, ASDA (a UK supermarket) lard, Napolina™ olive oil, stock margarine, peanut oil, a blend (chorizo grease, bacon grease and cooking oil) and hamburger grease, is dried on blue CW99 knitted cotton fabric swatch. The standardized stained swatch is available from Warwick Equest Ltd. (Durham, UK). The swatches should be pre-labeled for identification purposes.

A control detergent formula containing no polymer is prepared, as is a comparable test detergent formula containing 1% polymer by weight spiked into the control formula. The control formula and the test formula are identical, except for the 1% polymer spiked into the test formula, and the resulting 1% dilution (considered negligible) of the formula.

A stock hardness solution of 205 ppm CaCO₃ and 87 ppm MgCO₃ in water is prepared, and the following test is conducted:
1. Add 33 L of the hardness solution to the washing tub of a semi-automatic twin tub washing machine (Panasonic, model # XPB 52-500S, Huangzhou, China).
2. Add 80 g of the control product to the washing tub and agitate for 3 minutes to dissolve the product.
3. 0.65 kg of ballast (clean, white cotton T-shirts) is added to the washing tub.
4. Place the stained swatch into the washing tub, and another 0.65 kg of ballast is added on top of the swatch.
5. Wash the stained fabric for 20 minutes (standard setting). Drain the washing tub.
6. Transfer the load from the washing tub to the spinning tub and spin for 3 minutes (standard RPM).
7. Add 33 L of the hardness solution to the washing tub for the rinse cycle. Transfer the load from the spinning tub to the washing tub and rinse for 5 minutes on a standard setting. Drain the washing tub.
8. Repeat steps 1-7 for the test formula and with a new stained swatch.
9. Air-dry the swatches for 24 hours at 25° C. and 35% humidity. During drying and afterwards, the swatch is kept away from direct sunlight. Store the swatch in the dark, and in a refrigerator at about 4° C.
10. The swatches are then graded with an Image Analyzer which is a closed light booth (Mole-Richardson (Molequartz model # 2581, Hollywood, Calif., USA)) containing a D65 light source and a Sony Corp. DXC-760MD digital camera which measures the color of the each stain spot and compares them with the corresponding stain spot on an unwashed (i.e., a “new”) stained swatch. The D65 light source mimics the wavelengths of actual sunlight. The data is transferred to a computer which calculates the percentage removal of the each stain spot based on the percentage difference in color for each spot. The swatches are graded within 1 day of completing the drying process.
11. The grease cleaning performance for a specific detergent formula is calculated by averaging the percentage removal of each stain spot.

The grease cleaning performance indexₛ (GCPIₛ) quantifies the surfactant reduction enabled by the polymer, while maintaining overall equal grease cleaning performance. Thus, a detergent composition containing the polymer is compared to a detergent composition having overall equal grease cleaning performance, but which requires more surfactant.
GCPIₛ={1-[(amount of surfactant in Formula A)/(amount of surfactant in Formula B)]}*100,
where Formula A is a detergent composition containing the polymer and Formula B is a detergent composition which is identical, except that it does not contain the polymer. Formula A and Formula B provide equal grease cleaning according to the grease cleaning test. As used herein, “equal grease cleaning” means that the average cleaning measurement of all of the stain spots is equal in magnitude. In an embodiment herein the GCPIₛ is at least about 10, or from about 10 to about 90, or from about 12 to about 80, or from 15 to about 75, or from about 20 to about 67.

Similarly, the grease cleaning performance indexₛₑ (GCPIₛₑ) quantifies the surfactant reduction enabled by the combination of the polymer+lipase, while maintaining overall equal grease cleaning performance.
GCPIₛₑ={1-[(amount of surfactant in Formula A)/(amount of surfactant in Formula B)]}*100,
where Formula A is a detergent composition containing the polymer and lipase, and Formula B is a detergent composition which is identical, except that it contains neither the polymer nor lipase. Formula A and Formula B provide equal grease cleaning according to the grease cleaning test. In the GCPIₛₑ and GCPI_{be} (below) tests, the lipase level is standardized at 100 LU/g of the detergent composition. In an embodiment herein the GCPIₛₑ is at least about 10, or at least about 15, or from about 15 to about 95, or from about 17 to about 90, or from 20 to about 85, or from about 22 to about 75.

The grease cleaning performance index_{b} (GCPI_{b}) quantifies the inorganic detergent builder reduction enabled by the polymer, while maintaining overall equal grease cleaning performance.
GCPI_{b}={1-[(amount of inorganic detergent builder in Formula A)/(amount of inorganic detergent builder in Formula B)]}*100,
where Formula A is a detergent composition containing the polymer and Formula B is a detergent composition which is identical, except that it does not contain the polymer. Formula A and Formula B provide equal grease cleaning performance according to the grease cleaning test. In an embodiment herein the GCPI_{b} is at least about 10, or from about 10 to about 100, or from about 12 to about 80, or from 15 to about 75, or from about 20 to about 67.

Similarly, the grease cleaning performance index_{be} (GCPI_{be}) quantifies the inorganic detergent builder reduction enabled by the combination of the polymer+lipase, while maintaining overall equal grease cleaning performance.
GCPI_{be}={1-[(amount of inorganic detergent builder in Formula A)/(amount of inorganic detergent builder in Formula B)]}*100,
where Formula A is a detergent composition containing the polymer and lipase, and Formula B is a detergent composition which is identical, except that it contains neither the polymer nor lipase. Formula A and Formula B provide equal grease cleaning according to the grease cleaning test. In an embodiment herein the GCPI_{be} is at least about 10, or at least about 15, or from about 15 to about 100, or from about 17 to about 100, or from 20 to about 85, or from about 22 to about 75.

In many cases, the polymer may be more effective on a weight-for-weight basis than an equal amount of surfactant and/or builder. The ratio between the weight % of the polymer and the GCPIₛ (i.e., weight % polymer: GCPIₛ) (and/or GCPI_{b}) of the detergent composition is at least about 1:2, or from about 1:2 to about 1:90, or from about 1:2.5 to about 1:90, or from about 1:3 to about 1:90, or from about 1:10 to about 1:90. The weight % polymer:GCPIₛₑ (and/or GCPI_{be}) of the detergent composition is at least about 1:2, or from about 1:2 to about 1:90, or from about 1:5 to about 1:90, or from about 1:10 to about 1:90, or from about 1:15 to about 1:90. If the ratio between the weight % of the polymer and the GCPIₛ is 1:2, then 1% of the polymer effectively allows a 2% reduction in the level of total surfactant, while providing overall equal grease cleaning performance.

The clay suspension test is performed as follows: 15 mg China clay (Warwick Equest Ltd.) is suspended in 15 mL demineralized water in a 30 mL flat-bottom beaker while stirring. 11 mg of a pH 7.5 buffer solution (see below) is added. The mixture is sonicated for 30 minutes and then stirred for 20 minutes. 0.15 mL of 0.1 M CaCl₂ water solution of is added with stirring and the mixture stirred for another 5 minutes. A water solution of polymer (0.075 mg, 2000 ppm in water) is added while stirring and the mixture stirred for another 5 minutes. A water solution of linear alkyl benzene (0.15 g, 5000 ppm in water) is added while stirring and the mixture stirred for another 5 minutes. The stirring is stopped and the mixture is allowed to rest for 60 minutes. This provides a polymer concentration of 10 ppm.

150 uL is taken from 2 mm beneath the liquid surface level and the optical density at 620 nm wavelength (turbidity) is measured with a BMG FLUOstar instrument. The resulting optical density value is then indexed against the optical density value obtained for Lutensit K-HD96® (commercialized by BASF) used as a reference value of 100; i.e.:
Clay Suspension Index=[optical transmission for polymer]/[optical transmission for Lutensit K-HD96]×100.

Buffer solution: A pH 7.5 buffer solution is prepared by mixing 50 mL of 0.1 M tris(hydroxymethyl)aminomethane, 40.3 mL of 0.1 M hydrochloric acid, and water (up to 100 mL total volume). Tris(hydroxymethyl) aminomethane is available from Riedel-deHaen under the commercial name of Trizma® base. Linear alkyl benzene was supplied from BASF under the commercial name of Lutensit™ A-LBN®.

In an embodiment herein, the clay suspension index is at least about 86, or from about 86 to about 600, or from about 90 to about 500, or from about 95 to about 460, or from about 100 to about 420, or from about 120 to about 390, or from about 150 to about 360, or 170 to about 340, or from about 200 to about 330. Without intending to be limited by theory, it is believed that the clay suspension index is an accurate and reproducible predictor of the overall whiteness maintenance properties of the polymer when it is added into a detergent composition according to the present invention.

The suds boosting index (SBI) measures the sudsing profile of the detergent composition with and without the polymer, in the presence of a standard amount of oil. The sudsing profile is measured by employing a suds cylinder tester (SCT), having a set of 4 cylinders. Each cylinder is 65 cm long, and 5 cm in diameter. The cylinder walls are 0.5 cm thick, and the cylinder bottom is 1 cm thick. The SCT rotates a detergent solution in the 4 clear plastic cylinders end-over-end, at a rate of 22 revolutions per minute after which the suds height is measured. Soil is added to the test solution prior to rotating the cylinders. Modifications of this test may be used to simulate the initial sudsing profile of a detergent composition, as well as its sudsing profile during use, as more soils are introduced to the solution from the items being washed.

The test method for the sudsing profile test herein is as follows:
1. Prepare a nil-soil test detergent solution containing the polymer, and a nil-soil control detergent solution lacking the polymer. The concentration of each detergent solution is 2414 ppm, and the hardness is standardized at 205 ppm CaCO₃ and 87 ppm MgCO₃. Dirty cooking oil and technical body soil (both available from Warwick Equest Ltd.) are used to simulate typical oils and body soils, respectively, in laundry. Technical body soil (i.e., “artifical sebum”=15% fatty acid; 15% oleic acid; 15% paraffin oil; 15% olive oil; 15% soya oil; 5% squalene; 5% cholesterol; 5% mystric acid; 5% palmitic acid; 5% stearic acid) is a liquid, while the dirty cooking oil is a cut-up swatch prepared from the dirty cooking oil spot of a fabric swatch discussed in the grease cleaning test, above. The dirty cooking oil spot is cut into equal ¼ portions, each portion of which becomes a “cut-up swatch”.
2. For each detergent solution, prepare a set of 4 clean, dry, calibrated cylinders.
3. For each detergent solution, pour 300 mL of detergent solution into each of the 4 replicate cylinders. Spike in 0.15 g of technical body soil, and a cut-up swatch.
4. Put a rubber stopper into each cylinder and lock the cylinders into the SCT.
5. Rotate the cylinders for 15 seconds. Stop the cylinders and lock each cylinder in a vertical and upright position. Within 10 seconds, measure the suds height of each cylinder to within 1 mm, going from left to right. Rotate the cylinders for another 15 seconds, stop and lock the cylinders in place, and re-measure the suds height. Repeat these rotation, stopping, locking and measuring steps, for additional rotation intervals of 30 seconds, 1 minute, 3 minutes, and 5 minutes. This provides datapoints for cumulative rotations of 15 seconds, 30 seconds, 1 minute, 2 minutes, 5 minutes and 10 minutes, simulating an in-use suds profile.

The sudsing profile is the average suds height, in mm, generated by the detergent composition at the datapoint which reflects 10 minutes of cumulative rotation. The suds boosting index (SBI) is the percentage increase in suds height at the 10 minute datapoint, due to the presence of the polymer, and is calculated as:
SBI={[(mm suds height with polymer)/(mm suds height without polymer)]−1}*(100)
The detergent composition herein typically has a suds boosting index of at least about 10, or from about 10 to about 80, or from about 15 to about 70.

To simulate the initial suds profile, the dirty cooking oil and technical body soil may be omitted from step 3, above. Additional variations of this test are possible, such as adding additional dirty cooking oil and/or technical body soil in between the various rotation intervals, until the suds level falls below a pre-determined level, for example, 1 cm. This provides a suds profile over a variety of soil concentrations, simulating the increase in soils which occur over time as more and more garments are washed. Alternately, varying amounts of prepared soil may be added to identical detergent solutions to simulate the washing of variously soiled garments as the first piece of laundry to be washed. Thus, use of the polymer herein may improve the suds profile of a detergent composition, especially the initial suds profile, and/or the in-use suds profile.

### EXAMPLE 1

The following laundry detergent formulations are prepared.

| | A | B | C | D | E | F | G | H | I | J |
|---|---|---|---|---|---|---|---|---|---|---|
| LAS | 18 | 18 | 18 | 18 | 17 | 17 | 15 | 17 | 11 | 13 |
| AE₃S | — | 0.4 | — | 0.4 | 0.4 | — | — | 0.4 | — | — |
| cationic surfactant | 0.2 | — | 0.2 | — | — | 0.2 | — | 0.6 | — | — |
| AE | — | — | — | — | — | — | 0.8 | — | 3.8 | 3 |
| polymer¹ | 1 | 1 | 1 | 1 | 1 | 1 | 0.75 | 1 | 1 | 1 |
| STPP | 17 | 17 | 19 | 19 | 17 | 17 | 21 | 17 | — | — |
| zeolite A | — | — | — | — | — | — | — | — | 1.3 | 19 |
| other enzyme² | 0.3 | 0.3 | 0.3 | 0.3 | 0.2 | 0.2 | 0.2 | 0.3 | 0.1 | 0.3 |
| bleach system | 3.1 | 3.1 | 3.5 | 3.5 | — | — | — | 3.1 | — | — |
| minors | bal. | bal. | bal. | bal. | bal. | bal. | bal. | bal. | bal. | bal. |
| GCPIₛ | 4 | 3.2 | 4 | 3.2 | 8.4 | 9.5 | 4.6 | 5.3 | — | — |
| GCPI_{b} | 15 | 15 | 5 | 5 | 15 | 15 | 16 | 15 | — | — |
| SBI | — | — | — | — | — | 15 | 5 | 10 | — | — |

¹6,000 g/mol Mw polyethylene glycol backbone grafted at 70° C. with 60% vinyl acetate by weight of the backbone.
²Non-lipase enzymes.
³e.g., carbonate, fillers, brightener, perfume, etc. to balance to 100%.

### EXAMPLE 2

The following laundry detergent formulations are prepared.

| | A | B | C | D | E | F | G | H | I | J |
|---|---|---|---|---|---|---|---|---|---|---|
| LAS | 17 | 17 | 17 | 17 | 16 | 16 | 14 | 16 | 11 | 13 |
| AE₃S | — | 0.4 | — | 0.4 | 0.4 | — | — | 0.4 | — | — |
| cationic | 0.2 | — | 0.2 | — | — | 0.2 | — | 0.6 | — | — |
| surfactant | | | | | | | | | | |
| AE | — | — | — | — | — | — | 0.8 | — | 3.8 | 3 |
| polymer¹ | 1 | 1 | 1 | 1 | 1 | 1 | 0.75 | 1 | 1 | 1 |
| STPP | 16 | 16 | 18 | 18 | 15 | 15 | 21 | 16 | — | — |
| zeolite A | — | — | — | — | — | — | — | — | 1.3 | 19 |
| lipase (LU/g)² | 100 | 100 | 100 | 100 | 100 | 100 | 100 | 100 | 100 | 100 |
| other enzyme³ | 0.3 | 0.3 | 0.3 | 0.3 | 0.2 | 0.2 | 0.2 | 0.3 | 0.1 | 0.3 |
| bleach system | 3.1 | 3.1 | 3.5 | 3.5 | — | — | — | 3.1 | — | — |
| minors⁴ | bal. | bal. | bal. | bal. | bal. | bal. | bal. | bal. | bal. | bal. |
| GCPIₛₑ | 9.5 | 8.4 | 9.5 | 8.4 | 14 | 15 | 12 | 11 | — | — |
| GCPI_{be} | 19 | 19 | 10 | 10 | 25 | 25 | 16 | 20 | — | — |
| SBI | 10 | 15 | 10 | 20 | — | — | — | — | — | — |

¹6,000 g/mol Mw polyethylene glycol backbone grafted at 70° C. with 60% vinyl acetate by weight of the backbone.
²LIPEX ® from Novozymes A/S.
³Non-lipase enzymes.
⁴e.g., carbonate, fillers, brightener, perfume, etc. to balance to 100%.

### EXAMPLE 3

The following laundry detergent formulations are prepared.

| | A | B | C | D | E | F | G | H | I | J | K | L |
|---|---|---|---|---|---|---|---|---|---|---|---|---|
| LAS | 16 | 16 | 17 | 19.4 | 17.6 | 15.9 | 16 | 16 | 17 | 19.4 | 13 | 17 |
| AE₃S | — | — | — | 0.9 | — | — | — | — | — | 0.9 | — | — |
| cationic | — | — | — | 0.2 | 0.2 | — | — | — | — | 0.2 | — | 0.6 |
| surfactant | | | | | | | | | | | | |
| AE | 0.8 | 1.3 | 2 | — | — | — | 0.8 | 1.3 | 2 | — | 0.3 | 0.4 |
| polymer¹ | 1 | 1 | 1 | 1.2 | 4 | 2 | — | — | 0.5 | 0.2 | 1 | 1 |
| polymer² | — | — | — | — | — | 2 | 1 | — | — | 0.5 | 1 | 0.5 |
| polymer³ | — | — | — | — | — | 1 | — | 0.5 | 0.5 | 0.5 | 1 | 0.5 |
| STPP | — | — | —⁶ | 24 | 20.3 | 10 | — | — | —⁶ | 24 | 17 | 16 |
| zeolite A | 16 | 16 | —⁶ | — | — | — | 16 | 16 | —⁶ | — | — | 1.5 |
| lipase | 50 | 100 | 100 | 200 | 100 | 100 | 100 | 400 | 100 | 100 | 100 | — |
| (LU/g)⁴ | | | | | | | | | | | | |
| other | 0.2 | 0.2 | 0.6 | 0.1 | 0.1 | 0.1 | 0.2 | 0.2 | 0.6 | 0.1 | 0.3 | 1.2 |
| enzyme⁵ | | | | | | | | | | | | |
| bleach | — | — | — | — | 3 | — | — | — | — | — | 1.5 | 6.6 |
| system | | | | | | | | | | | | |
| minors⁷ | bal. | bal. | bal. | bal. | bal. | bal. | bal. | bal. | bal. | bal. | bal. | bal. |

¹6,000 g/mol Mw polyethylene glycol backbone grafted at 70° C. with 60% vinyl acetate by weight of the backbone.
²6,000 g/mol Mw polyethylene glycol backbone grafted at 70° C. with 60% vinyl acetate by weight of the backbone, and 40% of ester links hydrolyzed.
³12,000 g/mol Mw polyethylene glycol backbone grafted at 70° C. with 54% vinyl acetate and 6% butyl acrylate by weight of the backbone.
⁴LIPEX ® from Novozymes A/S.
⁵Non-lipase enzymes.
⁶contains 22% carbonate + 6.4% silicate as a builder system.
⁷e.g., carbonate, fillers, brightener, perfume, etc. to balance to 100%.

### EXAMPLE 4

The polymer of EXAMPLE 1 is measured via NMR spectroscopy and found to contain 0.9 graft points per polyethylene glycol unit. The formulas of EXAMPLE 1 are repeated with polymers grafted at 90° C. and having 0.9 graft points and 0.8 graft points per polyethylene glycol unit. Similar results are achieved in both cases.

### EXAMPLE 5

In the clay suspension test, the polymer of EXAMPLE 1 with 0.9 graft points per polyethylene glycol unit provides a clay suspension index of 10% higher than a comparative polymer with 1.8 or 1.9 graft points per polyethylene glycol unit. Actual in-use whiteness maintenance results are similar.

### EXAMPLE 6

A polyethylene glycol (PEG)-backboned random graft polymer (Mw=12,000 g/mol; clay suspension index=269) is polymerized at a temperature of 70° C. which results in 0.8 vinyl acetate graft points per PEG moiety according to NMR analysis of the neat sample. The backbone Mw=6,000 g/mol. When 1% polymer is added to an anionic surfactant and STPP-containing detergent composition, it enables a GCPIₛ of 20 and a GCPI_{b} of 20. The ratio of weight % polymer:GCPIₛ=1:20, and the ratio of weight % polymer:GCPI_{b}=1:20. When 1.2% polymer is combined in a similar formulation with 0.3 LU/g (0.05 mg/L) hardness solution first wash lipex, the GCPIₛ=40, and GCPI_{b}=40. The GCPIₛₑ and GCPI_{be}=1:33.3. Under actual wash conditions where 39 g product is used per 33 L hardness solution, a formula containing 1% polymer allowed the complete removal of STPP builder, resulting in both GCPI_{b} and GCPI_{be} (at non-standard conditions where 39 g product is used per 33 L hardness solution)=100.

Similar results occur when the polymer has 0.9 vinyl acetate graft points per PEG moiety.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising, by weight:
A. from about 0.5% to about 20% of a polymer;
B. from about 1% to about 50% of a surfactant; and
C. the balance adjunct ingredients,
wherein the grease cleaning performance indexₛ of the detergent composition is at least about 10.

2. The detergent composition according to claim 1, comprising from about 0.6% to about 18% of a polymer.

3. The detergent composition according to claim 1, wherein the grease cleaning performance indexₛ is from about 10 to about 90.

4. The detergent composition of claim 1, further comprising, by weight from about 5% to about 40% of an inorganic detergent builder wherein the grease cleaning performance index_{b} of the detergent composition is at least about 10.

5. The detergent composition according to claim 4, comprising from about 0.6% to about 18% of the polymer.

6. The detergent composition according to claim 4, wherein the grease cleaning performance index_{b} is from about 10 to about 90.

7. The detergent composition according to claim 4, further comprising a lipase enzyme.

8. The detergent composition of claim 1, wherein the ratio between the weight % of the polymer and the grease cleaning performance indexₛ of the detergent composition is at least about 1:2.

9. The composition of claim 8, further comprising, by weight from about 5% to about 40% of an inorganic detergent.

10. The detergent composition according to claim 9, further comprising a lipase enzyme.

11. The detergent composition according to claim 1 further comprising a lipase enzyme wherein the grease cleaning performance indexₛₑ of the detergent composition is at least about 10.

12. The detergent composition according to claim 4 further comprising a lipase enzyme wherein the grease cleaning performance index_{be} of the detergent composition is at least about 10.

13. The detergent composition of claim 1 wherein the detergent composition has a clay suspension index of at least about 86.

14. The detergent composition according to claim 13, wherein the clay suspension index is from about 86 to about 600.

15. The detergent composition of claim 1, wherein the detergent composition has a suds boosting index of at least about 10.

16. The composition of claim 1, wherein the polymer comprises a polyethylene glycol backbone.

17. The composition of claim 1, further comprising:
A. from about 5 LU/g of the detergent composition to about 20,000 LU/g of the detergent composition of a lipase;
B. wherein a polymer comprising a polyethylene glycol backbone.

18. The detergent composition of claim 17, wherein the polymer has a weight average molecular weight of from about 1,000 g/mol to about 150,000 g/mol.

19. The detergent composition of claim 18, wherein the polymer comprises a moiety attached thereto, wherein the moiety is selected from the group consisting of a vinyl-acetate moiety, a butyl-acrylate moiety, and a mixture thereof.

20. The detergent composition according to claim 19, wherein the degree of hydrolysis of the polymer is from about 0 mol % to about 75 mol %.
